(19) United States
(12) Patent Application Publication
(10) Pub. No.: US 2021/0043098 A1
(43) Pub. Date: Feb. 11, 2021

(54) METHODS AND SYSTEMS OF ACTIVE DISCOVERY AND COLLABORATIVE COLLISION AVOIDANCE OF AIRCRAFTS

(71) Applicant: University of Electronic Science and Technology of China, Chengdu (CN)

(72) Inventors: Yulin Wang, Chengdu (CN); Yu Luo, Chengdu (CN); Siyu Zhan, Chengdu (CN); Pengfei Liu, Chengdu (CN)

(73) Assignee: University of Electronic Science and Technology of China

(21) Appl. No.: 16/672,434

(22) Filed: Nov. 2, 2019

(30) Foreign Application Priority Data
Aug. 6, 2019 (CN) 201910720926.0

(51) Int. Cl. G08G 5/04; G08G 5/00; G05D 1/10

(52) U.S. Cl. CPC G08G 5/04; G05D 1/101; G08G 5/0008

(57) ABSTRACT

Methods and systems of active discovery and collaborative collision avoidance are described for aircrafts. Specifically, an aircraft predicts firstly the four-dimensional information of its short future flight path based on existing information, then shares the information actively among its adjacent aircrafts, realizes finally collaborative collision avoidance based on the future flight paths of adjacent aircrafts. The described methods contain the following steps: prediction and broadcast of short future flight path, broadcast reception and analysis and collision avoidance, and resumption of planned path and state. According to the methods, a system is also described to implement the above method and it contains seven corresponding modules. Since sharing the future information rather than the past information among aircrafts, the advantage of this intervention is strong real-time, low computation complexity, low cost, and more aircrafts accommodated in the same space.

### CROSS-REFERENCE TO RELATED APPLICATIONS

This application claims priority to Chinese Patent Application No. 201910720926.0 with a filing date of Aug. 6, 2019. The content of the aforementioned applications, including any intervening amendments thereto, are incorporated herein by reference.

### BACKGROUND

### 1. Technical Field

The present disclosure generally relates to the collaboration technology of multiple aircrafts and, more particularly, to active discovery and collaborative collision avoidance methods and systems.

### 2. Description of the Related Art

The technical development is making low altitude flight, super low altitude flight more and more popular. Compared with high altitude flight or super high altitude flight, low or super low altitude flight have lower altitude, high velocity relative to ground and more demanding in the operation and control of aircrafts, such as shorter processing time and smaller processing deviation. Therefore, autonomous flight control or auxiliary flight control is crucial for improving the operability and safety of low altitude aircrafts.

The collision avoidance processing is one important component of autonomous flight control or auxiliary flight control. Existing collision avoidance systems, the typical examples of which is such as drones and robots, primarily focus on avoiding static obstacles. In the cases that multiple aircrafts fly simultaneously in the same space, the main obstacles are other dynamic aircrafts. An effective approach to solving the collision avoidance problem between aircrafts is to design and implement an efficient resolution mechanism of flight space conflicts.

Existing resolution mechanisms of flight space conflicts contain mainly two classes. The first one is to adopt ground control systems, in which all the aircrafts in the same space communicate with air traffic control systems in real time. When a space conflict may occur, the ground crew or the ground intelligent decision systems make conflict avoidance decision, and then send a command to the corresponding aircraft for avoiding space conflicts. This class of methods have some disadvantages, such as high requirements for ground monitoring devices, low coverage range, low system expandability, a limited number of aircrafts that can be served simultaneously, and small space which can be managed and controlled. The second class of resolution mechanisms is to adopt the technology of perception-avoidance. That is, a variety of detection devices are mounted on each aircraft for sensing the surrounding aircrafts, such as visual recognition systems and radar detection systems. An aircraft makes an avoidance decision by itself based on the results of perceiving, and then plans, controls and executes the avoidance operations. Each active detection technology has its own specialty and problems. For example, visual detection is limited by visible light, and has a short viewing distance, then it is suitable for low speed aircrafts. Radar detection has heavy self-weight, high cost and complex operations. The data fusion technology of multiple sensors is currently immature, and this leads to an incomplete sensing of real time surrounding environment of dynamic aircrafts. If an aircraft makes an avoidance decision by itself, the collision between aircrafts is still inevitable.

### SUMMARY OF THE DESCRIPTION

The disclosure aims to the disadvantage of existing technology, and proposes a method and system of active discovery and collaborative collision avoidance for aircrafts. The method makes the analysis and prediction of space collision based on the active discovery mechanism of aircrafts. In the process of active discovery, each aircraft first predicts its short future flight path based on the history of its own flight trajectory, the planned path and the current flight state, and then broadcasts the prediction results to adjacent aircrafts. Different from the existing methods, the shared information among aircrafts is their own short-future intention rather than the past state. Therefore, the analysis and prediction of space collision is more accurate and more efficient.

When a future space collision exists, a solution of collision avoidance and a resumption method of planned path and state are proposed in the disclosure. The solution of collision avoidance is based on priority. Each aircraft with lower priority implements collision avoidance by adjusting temporarily flight altitude, flight direction and flight speed. After a space collision has been resolved, an aircraft resumes the planned path and state by adjusting its flight state again. Compared with other methods, the proposed method has higher prediction accuracy, timelier collision avoidance and lower cost.

### BRIEF DESCRIPTION OF THE DRAWINGS

The drawings help to provide further understanding of the technical scheme of the invention, and form a part hereof. They explain the invention with the embodiments of the invention, but do not confine the technical scheme of the invention.

FIG. 1 is a flowchart illustrating the prediction and active broadcast of the short future flight path of an aircraft according to the invention;

FIG. 2 is a state transmission diagram of aircraft flight modes according to the invention;

FIG. 3 is a flowchart illustrating the reception, the analysis and the collision avoidance of aircrafts according to the invention;

FIG. 4 is a flowchart illustrating the resumption of planned flight path and state according to the invention;

FIG. 5 is a block diagram illustrating an active discovery and collaborative collision avoidance system of aircrafts according to the invention.

### DESCRIPTION OF THE PREFERRED EMBODIMENTS

To explain the purpose, the technical scheme and advantages of the invention more clearly, the typical embodiment of the invention is descripted in detail with the attached drawings. Obviously, the descripted embodiment is an embodiment of the invention in some cases, rather than in all the cases. It is noteworthy that the embodiments of the invention or the features of the embodiment can be combined freely in the case of no conflicts.

The given steps of the flowcharts in the attached drawings can be executed in a computer system, which can run a group of computer executable instructions. Although the flowcharts have given the logical order, the given or described steps can be executed in some cases in a different order from here.

The application scope of the embodiment is the case of the warning and processing of collision avoidance when multiple aircrafts fly in the same space. The executor of the embodiment is the processing systems of collaborative collision avoidance in an aircraft. The systems can be the information processing platform of an aircraft, an independent part, a part appended to a flight control processor or other existing computing processors. Since aircrafts need to broadcast in the nearby airspace, a processing system of collaborative collision avoidance contains a wireless communication module in addition to the processor. The module includes but does not limit to WiFi, Bluetooth, and mobile communication and so on. Furthermore, because an aircraft needs to broadcast the spatiotemporal information of its short future flight path, the processing system of collaborative collision avoidance also contains the sensing module of space position, including but not limited to outdoor positioning modules, such as GPS (Global Positioning System) and BDS (BeiDou Navigation Satellite System), and indoor positioning modules, such as three-dimensional ranging radars.

An aircraft broadcasts continually the spatiotemporal information of its short future path in the nearby airspace, meanwhile it receives and processes the spatiotemporal information of the short future paths of the other aircrafts in the nearby airspace. The three tasks, i.e., the spatiotemporal information broadcast of flight paths, the spatiotemporal information receipt of flight paths and the adjustment of flight state, are always executed concurrently without any particular order. The broadcast content contains the latest forecast results of the spatiotemporal information of flight paths, the priority and the feature of the aircraft itself. Correspondingly, the broadcast receipt content also contains the latest forecast results of flight paths, the priority and the feature of the other aircrafts in the nearby airspace. The adjustment basis of flight state for collision avoidance is also the latest flight state and the latest forecast results of flight paths of all the aircrafts in the nearby airspace.

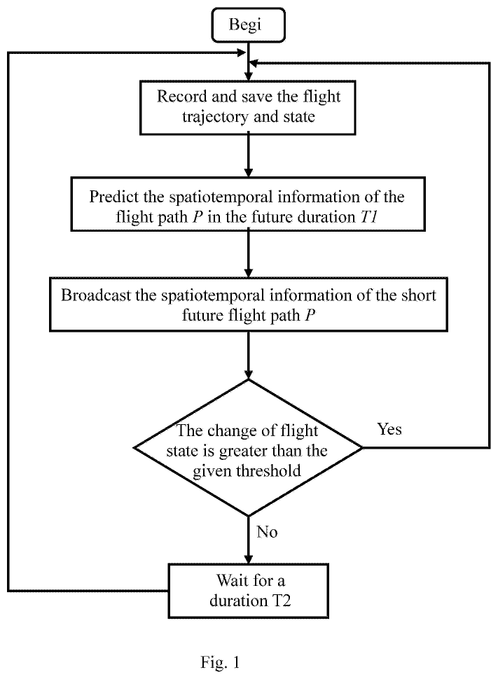

FIG. 1 is a flowchart illustrating the prediction and active broadcast of the short future flight path of an aircraft according to the invention. It contains the following steps:

Step S100. Record and save the flight trajectory and state when an aircraft flies. The flight trajectory is the path along which the aircraft has flew, including the space position and the corresponding moment. The flight state contains speed, attitude, and acceleration and so on.

Step S200. Predict the spatiotemporal information of the flight path P of the aircraft in a short future duration T1. The duration T1 can be fixed, such as 30 seconds, 1 minute or 2 minutes, or be variable. For example, the duration can be determined by both the current flight speed V1 and the response speed V2 of state adjustment. The spatiotemporal information of the short future flight path P contains the temporal information and the spatial information. The temporal information may be the absolute time by which all the aircrafts of the airspace keeps consistent, or be a relative time based on a special moment.

The spatiotemporal information of the short future flight path P is predicted based on the current flight orientation, the flight speed and the planned paths, as well as the historical flight trajectory and state saved in Step S100. The prediction algorithms can be an arbitrary algorithm of trajectory prediction, for example, filters, neural networks, deep learning, mathematical statistics and heuristic methods.

Step S300. Broadcast the spatiotemporal information of the short future flight path P. The broadcast coverage is the airspace covered by the wireless communication. The layer of implementing broadcast can be the link layer, network layer or application layer.

Since each aircraft is not an abstract point, but has its own three dimensional information, such as length, width and height. The broadcast content contains the feature of the aircraft in addition to the abstract flight path and the corresponding moment of appearance, such as three dimensional information and safe distance. To solve the subsequent space conflicts more conveniently, the broadcast content also contains the pass priority.

Step S400. Check whether the change of flight state is greater than the given threshold. The threshold can be set according to the forecast precision of the spatiotemporal information of short future paths. The higher the accuracy requirement is, the smaller the threshold is set. Otherwise, the lower the accuracy requirement is, the bigger the threshold is set. The threshold can also be determined dynamically by the existing aircraft number of the airspace. The more the existing aircraft number of the airspace, i.e., the density of air traffic is high, the higher the forecast accuracy requirement of flight paths and the lower the threshold is set correspondingly. On the contrary, the less the existing aircraft number, i.e., the density of air traffic is low, the bigger the threshold is set.

When the change of flight state is greater than the given threshold, it shows that there is a great difference between the currently predicted flight path and the true flight path in future. It is needed to go back to Step S100 and to predict and broadcast again. Otherwise, if the current change of flight state is smaller than the threshold, it is shown that the predicted results is basically consistent with the true flight path in future, then execute Step S500.

Step S500. Wait a time period T2, then go back to execute Step S100 for prediction and broadcast again. The time period T2 can be fixed, such 10 seconds and 20 seconds, or be set dynamically according to the aircraft number of the current airspace. When the aircraft number of the airspace is greater, i.e., the density of air traffic is high, the time period T2 is set smaller. In the contrary, when the density of air traffic is low, the time period T2 is set bigger. The total cost of bandwidth and processing will decrease with the increase of the time period T2.

To illustrate conveniently, three flight modes are divided: the normal flight mode, the collision avoidance flight mode and the resumption flight mode. The normal flight mode means that an aircraft flies along the planned path or by the planned mode, and there is no temporarily dynamic adjustment of flight state during the flight process. The collision avoidance flight mode means that an aircraft needs to adjust continuously the flight state for collision avoidance. In the case that there is a planned path, the flight path may be temporarily inconsistent with the planned path or the points in time. In the case of no planned paths, the aircraft does not continue to fly by the previous flight state, but adjusts the previous flight state. The resumption mode means that an aircraft returns to the planned flight path or state by dynamical adjustment after the aircraft has deviated from the planned flight path or state.

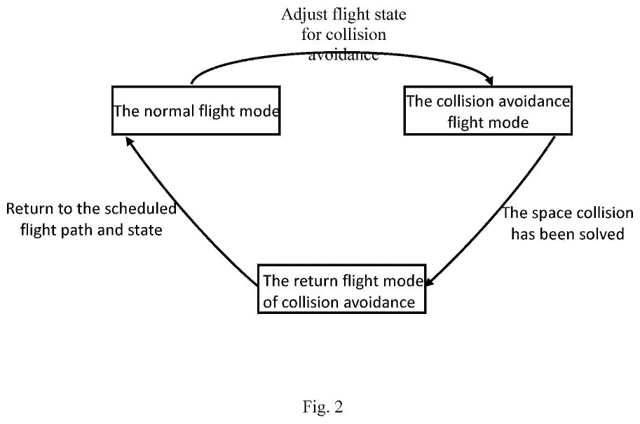

The state transmission diagram of three flight modes is illustrated in FIG. 2. When an aircraft starts to fly, the corresponding mode is the normal flight mode. When needing to avoid the collision among aircrafts, an aircraft goes into the collision avoidance flight mode by the dynamical adjustment of flight state. After the adjustment of flight state, the aircraft will deviate from the planned flight path or be inconsistent with the planned state. After the space collision has been resolved, an aircraft flies in the resumption flight mode and readjusts flight state to return the planned flight path or state. When an aircraft has returned to the planned flight path or state, it goes into the normal flight mode again.

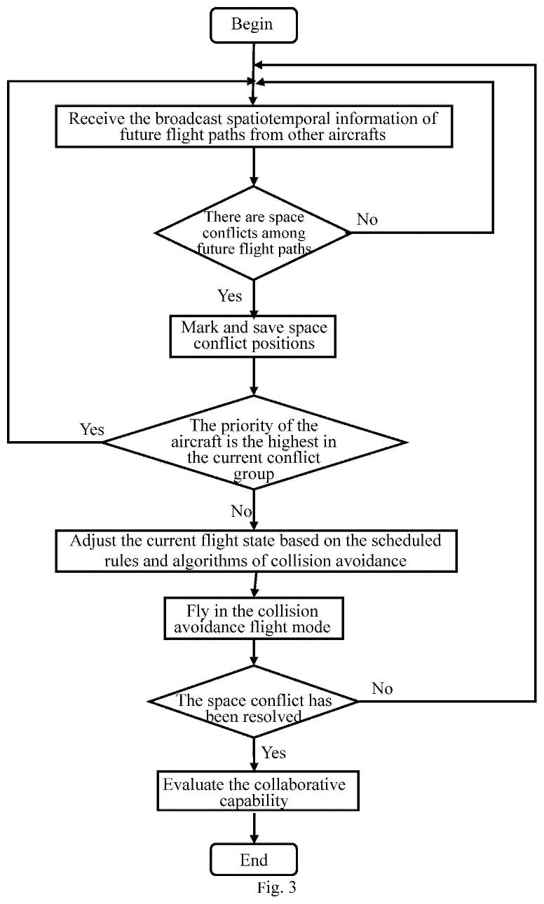

FIG. 3 is a flowchart illustrating the reception, the analysis and the collision avoidance of aircrafts according to the invention. It contains the following steps:

Step T100. Receive the broadcast spatiotemporal information of the short future flight paths from other aircrafts. When the distance between an aircraft B and another aircraft A is less than the communication coverage, aircraft B can receive the spatiotemporal information of short future flight paths from aircraft A.

Step T200. Analyze future space conflicts based on the short future flight path information of the aircraft itself and of all the other aircrafts from broadcast. When two aircrafts appear simultaneously in the space position L at the future time t1, a space conflict exists. Here the space position L is not an abstract point, but a space which contains the three dimensional information of aircrafts and safe distance. The safe airspace of an aircraft is a three dimensional space which consists of the three dimensional information of the aircraft and the safe distance. The safe airspace can be abstracted as including but not limited to cylinder, cuboid and ellipsoid and so on.

If no conflicts exist at present, return to Step T100 and continue to receive broadcast from other aircrafts, otherwise, go to execute Step T300.

Step T300. Mark and save the future space conflict position L for bypassing the conflict position L in the subsequent adjustment of flight state or flight paths.

Step T400. If the aircraft's priority is the highest among all the aircrafts of the current conflict group, then return to Step T100 for continuing to fly along the original planned path, otherwise, go to execute Step T500;

The negotiation methods of space conflicts contain but do not limit to priority. Other ways can also be adopted, such as establishing communication links among all the conflicted aircrafts and solving space conflicts with communication negotiation. In addition, the flight priority of aircrafts may be fixed, dynamic or mixed of both fixed and dynamic priority. Fixed priority is detrimental to the pass fairness among aircrafts; instead, dynamic priority can implement pass fairness. For example, an aircraft adds a bit of priority once it avoids a flight conflict actively.

Step T500. Adjust the flight state of the aircraft based on the scheduled rules and algorithms to ensure that it can bypass the conflict position L at the future time t1. The rules or algorithms of collision avoidance are arbitrary. The adjustment strategy of flight state contains acceleration, deceleration and detouring. The detour direction is arbitrary, such as up, down, left, right.

Step T600. Switch to the collision avoidance flight mode for the aircraft the flight state of which has been adjusted in Step T500.

Step T700. Check whether the space conflict has been resolved. If no, return to Step T100, otherwise, execute Step T800. The determination methods for space conflict resolution contain but do not limit to the following methods: 1) the aircraft itself has passed though the conflict position L; 2) all the other aircrafts of the conflict group have passed the conflict position L.

Step T800. Evaluate the collaborative capability of all the other aircrafts of the conflict group, then end. The evaluation of collaborative capability may be qualitative or quantitative. The qualitative evaluation contains following or breaking the rules of conflict resolution. The basis of quantitative evaluation contains but does not limit to the distance of conflict discovery, the response time of conflict resolution and so on. The evaluation objects contain all the other aircrafts of the conflict group, and the evaluation should be saved in the internal memory of the aircraft for subsequent analysis and utilization.

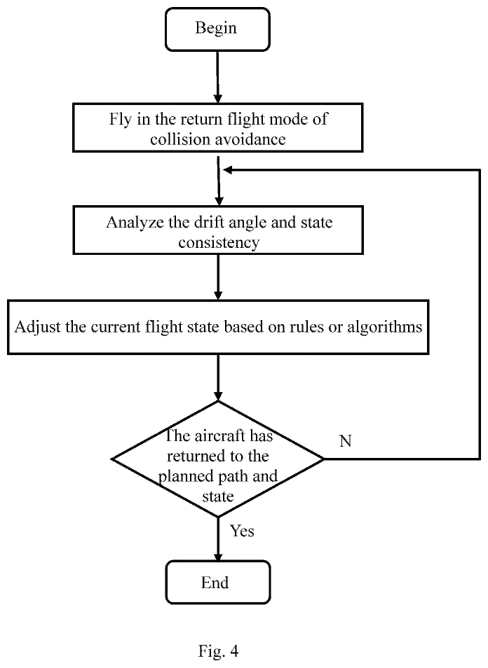

After an aircraft flies in the collision avoidance flight mode, the aircraft will deviate the planned flight path or flight state. After the collision avoidance flight mode ends, an aircraft switches to the resumption flight mode. And the aircraft returns to the planned flight path and state by adjusting the flight state once again. FIG. 4 is a flowchart illustrating the resumption of planned flight path and state according to the invention. It contains the following steps:

Step R100. Keep the aircraft operating in the resumption flight mode.

Step R200. Analyze the drift angle and state consistency. The analysis methods of drift angle contain but do not limit to the following methods: draw a conclusion of drift angle and state consistency by comparing the current flight path, position and state, such as speed and orientation with the planned path, position and state.

Step R300. Adjust the current flight state to return to the planned flight path and state based on the scheduled return rules and algorithms. The adjustment algorithms of flight state contain but do not limit to the optimization algorithms and the enforcement learning algorithms. In the path planning of returning to the planned paths, an aircraft should avoid the known areas of space conflicts. Since the flight state broadcast and receipt of aircrafts always keep running during the flight process, the known areas of space conflicts always keep up to date.

Step R400. Return to Step R200 under the condition that the aircraft has not returned to the planned path and state.

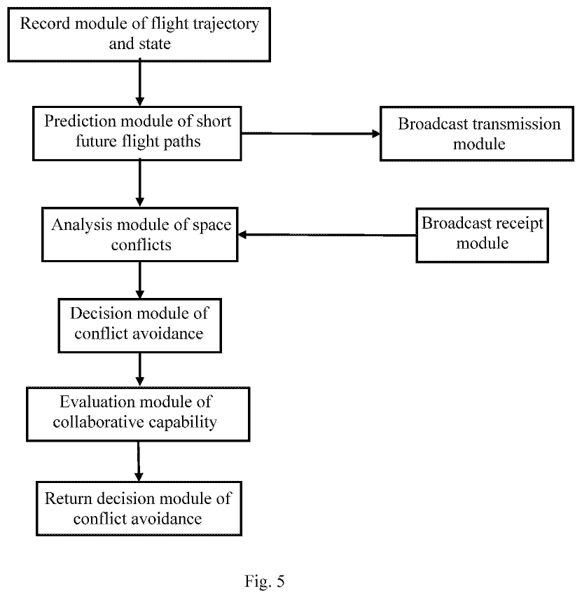

Furthermore, according to the aforementioned method of active discovery and collaborative collision avoidance of aircrafts, the invention provides an aircraft system of active discovery and collaborative collision avoidance. FIG. 5 is a block diagram illustrating an aircraft system of active discovery and collaborative collision avoidance according to the invention, comprising:

Record module of flight trajectory and state. The module records the flight trajectory and state of the aircraft, and provides the basis for the prediction of short future flight paths. The module always works during the whole flight process.

Prediction module of short future flight paths. According to the history of flight trajectory and the current flight state, the aircraft predicts its short future flight path with the corresponding prediction algorithms, such as statistical models and machine learning. The module provides data for the broadcast module. The module always works during the flight process too. The interval between two successive predictions depends on the change speed of flight state. When the flight state changes quickly, the accuracy of previous predictions is low and the interval of prediction processing should be short correspondingly. On the contrary, when the flight state changes slowly, the interval of prediction processing should be long.

Broadcast transmission module. The module broadcasts the spatiotemporal information P of its short future path during the flight process. The module always works during the flight process. Whenever a new prediction result is gotten, the module broadcasts the result, and the broadcast interval depends on the interval of prediction processing.

Broadcast receipt module. The module receives the spatiotemporal information P of short future paths from the other adjacent aircrafts. The module always works during the flight process too. All the aircrafts covered by the broadcast communication can receive the broadcast content.

Analysis module of space conflicts. The module compares the short future flight paths of the other aircrafts with the path of the aircraft itself. When two or more aircrafts appear in the same space position at the same point in future, a space conflict is found. The module also works always during the flight process. Whenever receiving a new broadcast, the module analyzes once.

Conflict resolution module. The module solves the space conflicts among several aircrafts. It decides whether to adjust temporarily flight orientation or speed etc., to avoid the conflict position, and then executes the corresponding adjustment according the decision. The module works only in the case that a space conflict is found and it is necessary to adjust the flight state.

Collaborative capability evaluation module. The module evaluates the collaborative capability of all the aircrafts of the conflict group after each space conflict has been solved, and saves the evaluation results.

Resumption decision module. The module makes a decision about returning to the planned flight path or state after a space conflict has been solved, and adjusts the flight state according to the decision. The module is executed in the case that it is necessary to return to the planned flight paths or state after a space conflict is solved.

The above module division is only one case among all the embodiments of the invention. The module recombination and rearrangement also belongs to the protection scope of the invention.

Obviously, the above embodiments are only some examples to illustrate the invention clearly, rather than the embodiment limitation of the invention. One of ordinary skill in the art can make some modification or change with different forms based on the invention. Herein it is unnecessary also unable to enumerate all the embodiments. Therefore, all the changes or modifications that come within the meaning and range of equivalency of the claims are to be embraced within their scope.

We claim:

1. A method for active discovery and collaborative collision avoidance of aircrafts, the method comprising:
a prediction step implemented actively and continuously to estimate an aircraft's short future flight path, said short future flight path estimated real-time on the basis of the flight trajectory, the flight state, the planned path, the planned flight mode and the zone information of space conflicts that has been marked and saved; said short future flight path comprising information about said aircraft, including three-dimension coordinate at each time epoch in the short future, the priority, the unique identifier and the collaboration capability; said short future designated as a fixed or variable time duration in future, said priority assigned to be static or dynamic;
a broadcast step implemented through wireless communication during the flight, and comprising broadcasting said prediction;
a reception step implemented by an aircraft that always receives the broadcast from its adjacent aircrafts during the flight;
an analysis step comprising space conflict detection in order to find out possible space conflicts in short future whenever aircraft receives a new broadcast or makes a new prediction;
a collision avoidance step implemented if necessary, and comprising operation of conflict resolution that leads an aircraft into the collision avoidance flight mode, which ends when the space collision has been resolved and the aircraft evaluates the collaborative capability of other aircrafts in the space conflict group, and the end of the collision avoidance flight mode;
an resumption of planned flight path and state implemented if the normal flight mode of an aircraft has been interrupted by said operation of conflict resolution, and comprising operation into the collision avoidance to normal transition flight mode, the analysis of the drift angle and state consistency, adjustment of the flight state, and recommencement of the planned flight path and state.

2. The method of claim 1, wherein said prediction and said broadcast comprise the following steps:
S100 recording and saving the flight trajectory and state;
S200 predicting the spatiotemporal information of the flight path P in the short future duration T1;
S300 broadcasting the spatiotemporal information of the short future flight path P;
S400 checking whether the change of flight state is greater than the given threshold; If yes, then returning to Step S100, otherwise, executing Step S500;
S500 waiting for a duration T2, then going back to execute Step S100.

3. The method of claim 1, wherein said reception, said analysis and said collision avoidance comprise the following steps:
T100 receiving the broadcast spatiotemporal information of the short future flight paths from other aircrafts;
T200 analyzing future space conflicts based on the short future flight path information of the aircraft itself and of all the other aircrafts received from broadcast; returning to Step T100 if no conflicts exist, or going to execute Step T300 otherwise;
T300 marking and saving the future space conflict position L;
T400 returning to Step T100 if the priority of the aircraft is the highest among all the aircrafts of the current conflict group, or going to execute Step T500 otherwise;
T500 adjusting the flight state of the aircraft based on the scheduled rules and algorithms to bypass the conflict space position L;
T600 switching to the collision avoidance flight mode;
T700 returning to Step T100 on condition that space conflict has been resolved, or going to execute Step T800 otherwise;
T800 evaluating the collaborative capability of all the other's aircrafts of the space conflict group.

4. The method of claim 1, wherein said resumption of planned flight path and state comprises the following steps:
R100 keeping aircraft operating in the resumption flight mode;
R200 analyzing the drift angle and state consistency;
R300 adjusting the current flight state to return to the planned flight path and state based on the scheduled rules and algorithms;
R400 returning to Step R200 under the condition that the aircraft has not returned to the planned path and state.

5. A system for active discovery and collaborative collision avoidance of aircrafts, comprising:
record module that records the flight trajectory and state of the aircraft, and provides the basis for the prediction of short future flight paths;
prediction module that estimates aircraft's short future flight path with the corresponding prediction algorithms, based on statistical models and machine learning, according to the history of flight trajectory and state;
broadcast transmission module that broadcasts the spatiotemporal information of aircraft's short future path P estimated by said prediction module during the flight process;
broadcast receipt module that receives the spatiotemporal information of short future paths P transmitted from the other adjacent aircrafts;
space conflict analysis module that detects space conflict by comparing the received short future flight paths of the other's aircrafts with that of the aircraft itself and searching for crossing point under spatial-time 4-D coordinate system;
conflict resolution module that resolves the space conflicts in the conflict group, by deciding whether to adjust temporarily flight paths or speed etc., so as to bypass the conflict point, and executing the corresponding adjustment in terms of the decision;
collaborative capability evaluation module that evaluates the collaborative capability of all the aircrafts inside the conflict group after each space conflict has been avoided, and saves the evaluation results;
resumption decision module that makes a decision about returning to the planned flight path or the planned flight state, and adjusts the flight state according to the decision.
